(19) United States
(12) Patent Application Publication
(10) Pub. No.: US 2012/0311505 A1
(43) Pub. Date: Dec. 6, 2012

(54) Document Management System and Program for the System

(75) Inventors: Yasuhiro MITO, Kyotonabe-shi (JP); Isao ISHIBASI, Settsu-shi (JP)

(73) Assignee: SHIMADZU CORPORATION, Kyoto-shi (JP)

(21) Appl. No.: 13/588,895

(22) Filed: Aug. 17, 2012

(30) Foreign Application Priority Data
Feb. 16, 2010 (JP) 2010-031165

(51) Int. Cl. G06F 3/048

(52) U.S. Cl. 715/853

(57) ABSTRACT

Provided is a document management system to be used in research institutes or similar organizations to utilize various data (documents) as intellectual properties, in which users can browse and locate documents from any desired point of view on a tree view showing folders with documents stored therein. The system allows users to assign each of the predetermined classifications, which are defined in a master file, to one of the hierarchical levels whose number equals that of the classifications. Subsequently, the system creates a tree view showing folders and documents based on the classifications respectively assigned to the hierarchical levels. Unlike conventional systems using fixed hierarchical structures, the present system allows users to freely change the hierarchical structure.

### TECHNICAL FIELD

The present invention relates to a system for managing electronic documents, and to a document management program for constructing such a system on a computer.

### BACKGROUND ART

In the field of research and development, the products of research and development activities (e.g. academic or technical papers) as well as the social accountability for the results of such activities conducted by organizations have become increasingly important. In line with this trend, it has been important, as a part of knowledge management (i.e. organizational sharing of intellectual properties for efficient business operations), to effectively collect intellectual properties resulting from research and development activities, promote the sharing of the collected information as useful knowledge, and effectively use the knowledge.

Such types of record management systems for electronic documents particularly designed for research and development operations have already been developed and provided for practical use. For example, a record management system for research and development disclosed in Non-Patent Document 1 has been developed in conformity to the guidelines defined in ISO 15489, an international standard for records management, which says that a record should correctly reflect what was communicated or decided or what action was taken. It should be able to support the needs of the business to which it relates and be used for accountability purposes. This record management system is capable of holding records including not only the research-related documents but also various kinds of contents produced in research and development activities, such as experimental data as well as analysis and measurement data, with metadata added thereto, which enables the efficient use of information, such as sharing information among project members or searching for a piece of knowledge obtained in previous projects.

### BACKGROUND ART DOCUMENT

### Non-Patent Document

Non-Patent Document 1: Yasuhiro Mito and Isao Ishibashi, “Kenkyuu Kaihatsu Muke Kiroku Kanri Sisutemu ‘GENZOU’ No Kaihatsu (Development of “Genzo” Record Management System for R&D Activities)”, Shimadzu Hyouron (Shimadzu Review), Vol. 64, No. 3-4 (April 2008), pp. 205-214

### SUMMARY OF THE INVENTION

### Problem to be Solved by the Invention

In conventional document management systems, including the one previously described, each document (which means any type of electronic document, such as a record, to be managed by the document management system) is classified into hierarchical management structures, such as large, middle and small classifications. When the documents are to be browsed, the system normally displays a tree view showing folders in a hierarchical form with the three levels of large, middle and small classifications.

However, displaying a list of files in a tree view provides a limited degree of freedom for browsing the documents.

For example, consider the case where the large, middle and small classifications are defined as follows:

Large classification: “Medical-Product Analysis Market” and “Environmental Analysis Market”

Middle classification: “Japan”, “USA” and “Europe”

Small classification: “GC (Gas Chromatograph)”, “LC (Liquid Chromatograph)”, “GCMS (Gas Chromatograph-Mass Spectrometer)” and “LCMS (Liquid Chromatograph-Mass Spectrometer)

In this case, it is possible to browse documents by following the tree in the normal order, e.g. from “Medical-Product Analysis Market” (large classification) through “USA” (middle classification) to “LCMS” (Liquid Chromatograph-Mass Spectrometer). However, it is impossible to browse documents by following the tree in an abnormal order, e.g. from “Medical-Product Analysis Market” (large classification) through “LCMS” (small classification) to “Japan” (middle classification).

The problem to be solved by the present invention is to provide a document management system, as well as a program for such a system, to be used in research institutes or similar organizations to utilize various data (documents) as intellectual properties, in which users can browse and locate documents from any desired point of view on a tree view showing folders with documents stored therein.

### Means for Solving the Problems

The present invention aimed at solving the aforementioned problem is a system for managing electronic documents having metadata in which a classification is written, the system having a function of displaying a tree view showing a plurality of documents in a hierarchically organized form using folders each of which corresponds to one classification, and the system including:

a) a master-file storage for storing a master file in which classifications are written, with one or more choice items defined for each of the classifications;

b) a hierarchical classification selector for allowing a user to assign each of the classifications written in the master file stored in the master-file storage, to one of the hierarchical levels whose number equals that of the classifications; and

c) a hierarchical view changer for creating a tree view showing folders and documents based on the classifications respectively assigned to the hierarchical levels by the hierarchical classification selector.

Another aspect of the present invention is a program for a system for managing electronic documents having metadata in which a classification is written, the program having a function of creating a tree view showing a plurality of documents in a hierarchically organized form using folders each of which corresponds to one classification, and the program being designed to be executed on a computer capable of accessing a master-file storage holding a master file in which classifications are written, with one or more choice items defined for each of the classifications, so as to make the computer function as:

a hierarchical classification selector for allowing a user to assign each of the classifications written in the master file stored in the master-file storage, to one of the hierarchical levels whose number equals that of the classifications; and

a hierarchical view changer for creating a tree view showing folders and documents based on the classifications respectively assigned to the hierarchical levels by the hierarchical classification selector.

### Effect of the Invention

By the document management system and document management program according to the present invention, users can freely change the assignment of the classifications to the hierarchical levels in the tree view. Users can design the hierarchical structure of the folders from any perspective based on their own interest so as to facilitate the management of the documents and thereby enable a more effective use of such intellectual properties. The system operability will also be improved because users can more quickly locate necessary documents.

### BRIEF DESCRIPTION OF THE DRAWINGS

FIG. 1 is a block diagram showing the schematic configuration of one embodiment of the document management system according to the present invention.

FIG. 2 shows one example of the master file.

FIG. 3 shows one example of a hierarchical classification selection screen.

FIGS. 4A and 4B show examples of a tree view of the folders in a document management system according to the present invention.

### BEST MODE FOR CARRYING OUT THE INVENTION

One embodiment of the document management system according to the present invention is hereinafter described in detail with reference to the attached drawings.

FIG. 1 shows a document management system 1 according to one embodiment of the present invention. The document management system 1 is actually a computer having a CPU (Central Processing Unit) 10. A memory 12, a monitor (display unit) 14 consisting of an LCD (Liquid Crystal Display) or similar device, an input unit 16 including a keyboard, mouse and/or other devices, as well as a storage unit 20 consisting of a hard disk drive or similar large-capacity storage, are mutually connected to the CPU 10.

A document management system program 21, a document storage section 22, and a master-file storage section 23 are provided in the storage unit 20. An OS (Operating System) 24 is also stored in the storage unit 20.

In FIG. 1 showing the document management system 1 according to the present invention, a hierarchical classification selector 31, a hierarchical view changer 32 and a document classification changer 33 are shown as subcomponents of the document management system program 21. Each of these subcomponents is basically realized as a software component by executing the document management system program 21 on the CPU 10. The document management system program 21 is hereinafter simply referred to as the “program 21.”

In the document storage section 22, various kinds of files being managed by the document management system 1 are stored. It should be noted that the “documents” in the present invention refer to a variety of files, such as a report in which the result of an analysis or measurement is collected or a research result is summarized. Each document includes a metadata in which the classification of the document is written.

A master file is stored in the master-file storage section 23. The classifications used in the document management system 1 and the choice items for each classification are the minimum pieces of information written in this master file.

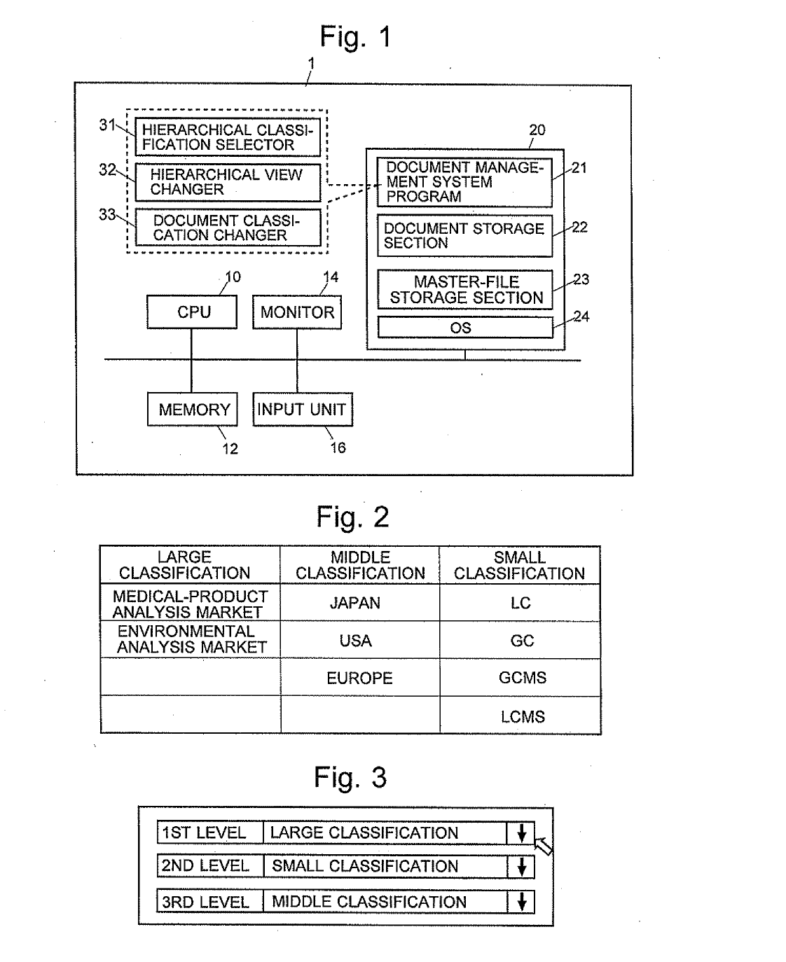

FIG. 2 shows one example of the master file. In this example, three classifications, i.e. the “large”, “middle” and “small” classifications are specified in the master file. The “large” classification has two choice items: “Medical-Product Analysis Market” and “Environmental Analysis Market.” The “middle” classification has three choice items: “Japan”, “USA” and “Europe.” The “small” classification has four choice items: “LC”, “GC”, “GCMS” and “LCMS.”

In the example shown in FIG. 1, both the document storage section 22 and the master-file storage section 23 are provided in the storage unit 20 of the document management system 1, which is actually a computer. Alternatively, the document storage section 22 and/or the master-file storage section 23 may be connected to the computer serving as the document management system 1 via a data communication network.

The document management system 1 has the function of creating a tree view in which the documents stored in the document storage section 22 are shown in a hierarchically organized form using folders corresponding to the classifications. For example, when a user presses the “View Folder” button (not shown) on the monitor 14 by appropriately operating the input unit 16, the document management system 1 displays the folders in a tree-view format at a predetermined position on the monitor 14. In this tree view, each level of the folders is organized in a hierarchical form and corresponds to one of the classifications specified in the master file.

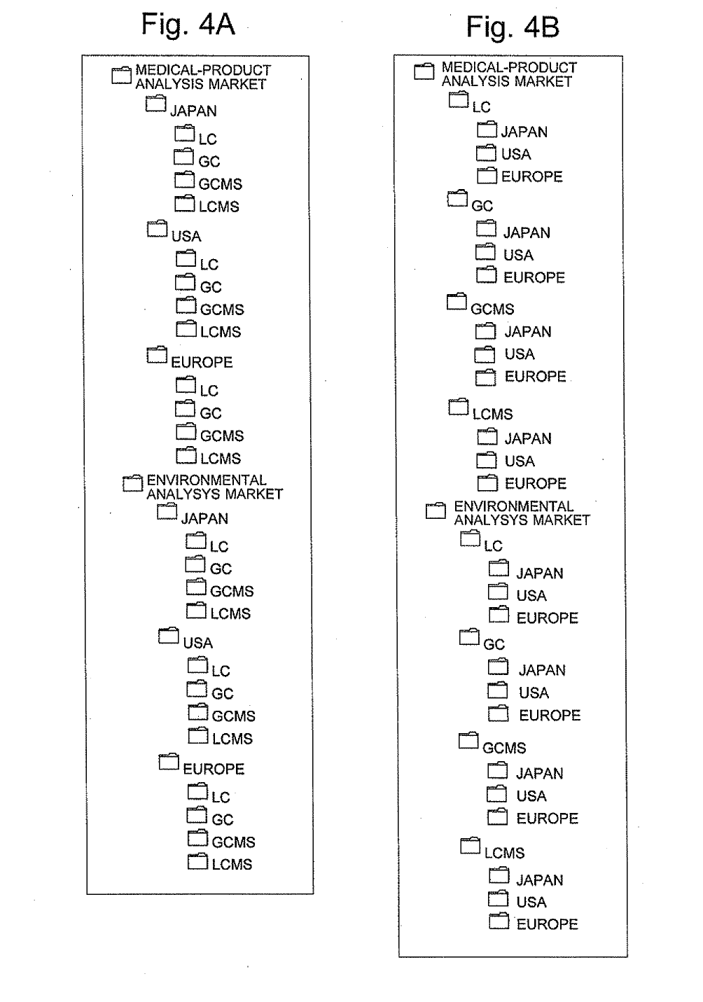

When the tree view is created according to the master file shown in FIG. 2, the “large” classification will be shown at the first level, the “middle” classification at the second level immediately below the first level, and the “small” classification at the third level immediately below the second level. In this case, the folders will be displayed as shown in FIG. 4A in a predetermined window on the monitor 14. When the folders are organized as shown in FIG. 4A, the user should sequentially follow the large, middle and small classifications to locate the desired document or any other document of interest.

Operations of the hierarchical classification selector 31 and the hierarchical view changer 32 characteristic of the present invention are hereinafter described.

When a user performs an appropriate operation on the input unit 16 (e.g. when the user presses the “Select Hierarchical Classification” button on the screen), the hierarchical classification selector 31 displays a hierarchical classification selection screen (as shown in FIG. 3) at a predetermined position on the monitor 14. Based on the fact that three levels of classifications (“large”, “middle” and “small” classifications) are written in the master file stored in the master-file storage section 23, the hierarchical classification selector 31 creates the hierarchical classification selection screen in such a manner that the same number of hierarchical levels as that of the classifications, i.e. the first, second and third levels, are shown in the screen so as to allow the user to assign the three classifications to the three hierarchical levels, respectively. In the example of the hierarchical classification selection screen shown in FIG. 3, the “large”, “small” and “middle” classifications are respectively assigned to the first, second and third levels by using a pull-down menu. Simultaneously assigning the same classification to different hierarchical levels is disallowed. Therefore, a warning message for informing the user of the invalid assignment may be issued against an attempt to make the disallowed selection.

Subsequently, when the user performs an appropriate operation on the input unit 16 (when the user presses the “Change Hierarchy View” button on the screen), the hierarchical view changer 32 creates a tree view showing the corresponding folders (and documents) according to the classification of each hierarchical level selected by the hierarchical classification selector 31. For example, the folders are displayed in a predetermined window on the monitor 14 as shown in FIG. 4B. When the folders are organized as shown in FIG. 4B, the user can sequentially follow the large, small and middle classifications. This order differs from that of the hierarchical structure of the folders shown in FIG. 4A.

It should be noted that the document management system according to the previously described embodiment of the present invention can be subjected to appropriate changes, modifications or additions within the spirit and scope of the present invention.

For example, as already stated, the program 21 includes a document classification changer 33, which rewrites the classification of a document written in the metadata of the document when the document is moved from the folder where the document is originally stored to another folder based on an order from the user. This function makes it possible to more flexibly manage the documents.

The document management system 1 may preferably maintain a movement history and keep track of the movement of the document.

The folders shown in FIGS. 4A and 4B are in the expanded form. It is naturally possible to design the tree view so that the folders can be expanded or collapsed, as in the case of commonly-known operating systems.

An even more user-friendly operational environment can be provided in various ways, e.g. by adding the function of counting the number of documents in each folder and showing the number near that folder.

### EXPLANATION OF NUMERALS

1 . . . Document Management System
10 . . . CPU (Central Processing Unit)
12 . . . Memory
14 . . . Monitor
16 . . . Input Unit
20 . . . Storage Unit
21 . . . Document Management System Program
22 . . . Document Storage Section
23 . . . Master-File Storage Section
24 . . . OS (Operating System)
31 . . . Hierarchical Classification Selector
32 . . . Hierarchical View Changer
33 . . . Document Classification Changer

1. A document management system for managing electronic documents having metadata in which a classification is written, the system having a function of displaying a tree view showing a plurality of documents in a hierarchically organized form using folders each of which corresponds to one classification, and the system comprising:
a) a master-file storage for storing a master file in which classifications are written, with one or more choice items defined for each of the classifications;
b) a hierarchical classification selector for allowing a user to assign each of the classifications written in the master file stored in the master-file storage, to one of hierarchical levels whose number equals that of the classifications; and
c) a hierarchical view changer for creating a tree view showing folders and documents based on the classifications respectively assigned to the hierarchical levels by the hierarchical classification selector.

2. The document management system according to claim 1, further comprising:
a document classification changer for rewriting the classification of a document written in the metadata of the document when the document is moved from the folder where the document is originally stored to another folder based on an order from the user.

3. A computer readable media recording a program for a system for managing electronic documents having metadata in which a classification is written, the program having a function of creating a tree view showing a plurality of documents in a hierarchically organized form using folders each of which corresponds to one classification, and the program being designed to be executed on a computer capable of accessing a master-file storage holding a master file in which classifications are written, with one or more choice items defined for each of the classifications, so as to make the computer function as:
a hierarchical classification selector for allowing a user to assign each of the classifications written in the master file stored in the master-file storage, to one of hierarchical levels whose number equals that of the classifications; and
a hierarchical view changer for creating a tree view showing folders and documents based on the classifications respectively assigned to the hierarchical levels by the hierarchical classification selector.

4. The computer readable media recording the program for a system for managing electronic documents according to claim 3, wherein the program makes the computer function as:
a document classification changer for rewriting the classification of a document written in the metadata of the document when the document is moved from the folder where the document is originally stored to another folder based on an order from the user.
